(19) United States
(12) Patent Application Publication
(10) Pub. No.: US 2026/0022575 A1
(43) Pub. Date: Jan. 22, 2026

(54) FLOOR-MOVING DEVICE

(71) Applicant: Weidong LI, Xinji City (CN)

(72) Inventor: Weidong LI, Xinji City (CN)

(73) Assignee: HEBEI SNDAS SURVEY AND DRAW CO., LTD., Xingtai City (CN)

(21) Appl. No.: 19/274,624

(22) Filed: Jul. 20, 2025

(51) Int. Cl. E04F 21/22; F16B 47/00

(52) U.S. Cl. CPC E04F 21/22; F16B 47/006

(57) ABSTRACT

The present invention discloses a floor-moving device, which comprises a housing, a suction cup and a striking element. The housing is provided with a deformation chamber and an opening. The opening communicates with the deformation chamber and is oriented downward. The suction cup is connected to the housing and covers the opening. The suction cup is used to adhere to the floor surface. The striking element is connected to the housing. The striking element is used to allow users to strike it, thereby driving the floor adhered to by the suction cup to move.

### TECHNICAL FIELD

The present invention relates to the field of floor installation and maintenance tools, particularly to a floor-moving device.

### BACKGROUND OF THE INVENTION

During the installation and use of floors, gaps often occur between the floorboards due to a variety of reasons, such as improper installation caused by non-standard operations of installers, deformation caused by changes in temperature and humidity in the environment, and normal wear and tear from long-term use. These gaps not only affect the aesthetic appearance of the floor but can also lead to dust accumulation and bacterial growth, and even pose a threat to the structural stability of the floor.

Existing floor repair tools on the market, although aimed at solving this problem, all have certain drawbacks. Some repair tools involve inserting the tool into the gap between the floorboards and then using a hammer to strike the tool to move the floor and restore it to its original position. However, in this method, the striking force of the hammer is difficult to precisely control, which can easily cause damage to the floor surface, affecting its appearance and service life. Moreover, inserting the tool into the narrow gaps between the floorboards can also cause damage to the floor. Other repair tools involve adhering a striking block to the floor and then striking the block to push the floor into place. This method, however, requires the additional step of adhering components to the floor. Not only is this process cumbersome, but removing the striking block can leave adhesive residue on the floor that is difficult to clean and may even damage the floor's surface coating.

To address these issues, the present invention provides a floor-moving device that can effectively solve the above-mentioned problems. It has a simple structure, is easy to use, provides even force distribution, can quickly and stably move the floor, and will not cause damage to the floor.

### SUMMARY OF THE INVENTION

To overcome the deficiencies of the existing technology, the present invention provides a floor-moving device that is simple in structure, easy to use, provides even force distribution, can quickly and stably move the floor, and will not cause damage to the floor.

The technical solution adopted by the present invention to solve its technical problem is as follows:

A floor-moving device, comprising:
A housing (110), the housing (110) having a deformation chamber (111) and an opening

(112), the opening (112) communicating with the deformation chamber (111) and being oriented downward;
A suction cup (120), the suction cup (120) being connected to the housing (110) and covering the opening (112), the suction cup (120) being used to adhere to the floor surface;
A striking element (130), the striking element (130) being connected to the housing (110), the striking element (130) being used to allow users to strike it, thereby driving the floor adhered to by the suction cup (120) to move.

Preferably, the striking element (130) has a striking surface, the striking surface being used to allow users to strike it.

Preferably, the normal to the striking surface is substantially perpendicular to the vertical axis of the housing (110).

Preferably, the striking element (130) comprises a main body part (131), a striking part (132) and two connecting parts (133), the two connecting parts (133) being bent and extended downward along the two sides of the main body part (131), the striking part (132) being bent and extended downward along the rear side of the main body part (131), and the inner surface of the striking part (132) being in contact with the end surfaces of the two connecting parts (133).

Preferably, the lower surface of the connecting part (133) is at least partially connected to the upper surface of the housing (110), and the side of the connecting part (133) away from the striking surface is connected to the side surface of the housing (110).

Preferably, the width of the striking part (132) is greater than the distance between the outer surfaces of the two connecting parts (133).

Preferably, the device further comprises an extension element (140), the extension element (140) comprising a plug-in block (141), a connecting rod (142) and a striking plate (143), the main body part (131) having a through-hole (1311), the plug-in block (141) being plugged into the through-hole (1311), the first end of the connecting rod (142) being connected to the plug-in block (141), the second end of the connecting rod (142) being extended in a direction away from the striking part (132) and connected to the striking plate (143), the striking element (130) being used to allow users to strike it.

Preferably, the second end of the connecting rod (142) is connected to the lower part of the striking plate (143), and the part of the striking plate (143) above the connecting rod (142) that is higher than the plane of the connecting rod (142) forms a striking area.

Preferably, the plug-in block (141) comprises an upper abutting part (1411), a connecting neck (1412) and a lower abutting part (1413), the upper abutting part (1411) and the lower abutting part (1413) being respectively connected to the upper and lower ends of the connecting neck (1412), the diameters of the upper abutting part (1411) and the lower abutting part (1413) being greater than the diameter of the connecting neck (1412), the upper abutting part (1411) and the lower abutting part (1413) being respectively clamped on the upper and lower sides of the main body part (131).

Preferably, the through-hole (1311) is in the shape of a light bulb, which includes an insertion area and a clamping area, the insertion area being located on the side of the clamping area away from the striking part (132), the diameter of the clamping area being matched with the diameter of the connecting neck (1412), and the diameter of the insertion area being greater than the diameter of the lower abutting part (1413).

Preferably, the device further comprises an eccentric handle (150) and a pull-up column (160), the housing (110) having a hole (113) in the middle, the lower end of the pull-up column (160) being connected to the suction cup (120), the upper end of the pull-up column (160) extending out of the hole (113), the eccentric part (151) of the eccentric handle (150) being rotatably connected to the upper end of the pull-up column (160) and being in contact with the housing (110), and driving the suction cup (120) to deform or reset through the pull-up column (160).

Preferably, the device further comprises a reset spring (170), the reset spring (170) being sleeved on the pull-up column (160), and its upper and lower ends respectively being in contact with the lower surface of the housing (110) and the upper surface of the suction cup (120), the reset spring (170) giving the suction cup (120) a tendency to reset.

Preferably, the device further comprises an installation sheet (180), the suction cup (120) having an installation slot (121), the installation sheet (180) being plugged into the installation slot (121), and the pull-up column (160) being connected to the installation sheet (180).

Preferably, the lower end of the pull-up column (160) has a protruding part (161), the installation sheet (180) has a pull-up column hole (181), the upper end of the pull-up column (160) extends out of the pull-up column hole (181), and the protruding part (161) is in contact with the lower surface of the installation sheet (180).

Preferably, the upper surface of the suction cup (120) also has an installation hole (122) communicating with the installation slot (121), the diameter of the installation hole (122) being greater than the diameter of the protruding part (161) and smaller than the diameter of the installation sheet (180).

Preferably, the reset spring (170) is a conical spring that is narrow at the top and wide at the bottom, the diameter of the lower end of the reset spring (170) being smaller than the diameter of the installation sheet (180), and the lower end of the reset spring (170) being in contact with the upper surface of the part of the suction cup (120) corresponding to the installation sheet (180).

Preferably, the device further comprises a washer (190), the upper surface of the housing (110) having a washer slot (114), the washer (190) being located in the washer slot (114), and the eccentric part (151) of the eccentric handle (150) being in contact with the upper surface of the washer (190).

Preferably, the eccentric part (151) of the eccentric handle (150) is rotatably connected to the upper end of the pull-up column (160) through a rotating shaft (154), the striking element (130) having an avoidance hole (1331), the avoidance hole (1331) being oppositely set to the rotating shaft (154) to allow the rotating shaft (154) to pass through.

Preferably, the handle part (152) of the eccentric handle (150) rotates between the suction position and the release position, when the handle part (152) is in the release position, the extension direction of the handle part (152) is substantially parallel to the vertical axis of the housing (110); when the handle part (152) is in the suction position, the extension direction of the handle part (152) is substantially perpendicular to the vertical axis of the housing (110), and the extension direction of the handle part (152) is away from the direction of the striking element (130).

Preferably, the surface of the handle part (152) has frictional patterns (153).

The beneficial effects of the present invention are as follows: By setting the above-mentioned structure, when in use, the suction cup is adsorbed on the floor, the edge of the opening of the housing is linked to the edge of the suction cup, ensuring that the edge of the suction cup is in the same plane, ensuring the structural stability of the suction cup. The deformation chamber allows the upper part of the suction cup to move upward to form a negative pressure between the suction cup and the floor surface, enabling the suction cup to more stably adhere to the floor surface. The striking element is connected to the housing, and users can use a hammer or other tools to strike the striking element to drive the housing, the suction cup, and the floor connected to the suction cup to move. This makes it convenient for users to move the floor. Moreover, by adsorbing the floor with the suction cup, the floor has a larger area of force, preventing floor damage during floor movement. Furthermore, by setting the striking element, the product can have more even force distribution, making it easier for users to move the floor in a specific direction. It is more convenient for users to use and can also prevent the housing from being damaged, which may affect the adsorption effect of the suction cup, thereby extending the service life of the product.

### BRIEF DESCRIPTION OF DRAWINGS

To more clearly illustrate the technical solution in the embodiments of the present invention, a brief introduction to the accompanying drawings that are needed in the description of the embodiments will be given below. The drawings described below are merely some embodiments of the present invention. For those of ordinary skill in the art, other drawings can also be obtained based on these drawings without making creative efforts.

The present invention will be further described below with reference to the accompanying drawings and embodiments.

FIG. 1 is a perspective view of the overall structure of the present invention when the eccentric handle is in the release position, from one angle;

FIG. 2 is a perspective view of the overall structure of the present invention when the eccentric handle is in the release position, from another angle;

FIG. 3 is a sectional view of the present invention when the eccentric handle is in the release position;

FIG. 4 is a perspective view of the overall structure of the present invention when the eccentric handle is in the suction position, from one angle;

FIG. 5 is a perspective view of the overall structure of the present invention when the eccentric handle is in the suction position, from another angle;

FIG. 6 is a sectional view of the present invention when the eccentric handle is in the suction position;

FIG. 7 is a perspective view of the overall structure of the present invention after the extension element is assembled, from one angle;

FIG. 8 is a perspective view of the overall structure of the present invention after the extension element is assembled, from another angle;

FIG. 9 is a sectional view of the present invention after the extension element is assembled;

FIG. 10 is a perspective view of the overall structure of the extension element of the present invention;

FIG. 11 is an exploded view of the present invention;

FIG. 12 is a view illustrating the usage state of the present invention;

FIG. 13 is a view illustrating the usage state of the present invention after the extension element is assembled.

### DETAILED DESCRIPTION OF THE INVENTION

To make the above-mentioned objectives, features, and advantages of the present application more apparent and understandable, a detailed description of the specific implementation methods of the present application will be given below in conjunction with the accompanying drawings. Many specific details are described in the following description to fully understand the present application. However, the present application can be implemented in many other ways different from those described herein. Without departing from the scope of the present application, those of ordinary skill in the art can make similar improvements. Therefore, the present application is not limited to the specific embodiments disclosed below.

In the description of the present application, it should be understood that if terms such as “center,” “longitudinal,” “transverse,” “length,” “width,” “thickness,” “up,” “down,” “front,” “back,” “left,” “right,” “vertical,” “horizontal,” “top,” “bottom,” “inner,” “outer,” “clockwise,” “counterclockwise,” “axial,” “radial,” “circumferential,” etc., appear, these terms indicate the orientation or position relationship based on the orientation or position relationship shown in the accompanying drawings. These terms are used only for the convenience of describing the present application and simplifying the description, and should not be understood as limiting the present application.

In addition, if terms such as “first” and “second” appear, these terms are used only for descriptive purposes and should not be understood as indicating or implying relative importance or implicitly indicating the quantity of the technical features indicated. Therefore, features defined by “first” and “second” may explicitly or implicitly include at least one such feature. In the description of the present application, if the term “multiple” appears, the meaning of “multiple” is at least two, such as two, three, etc., unless otherwise specifically limited.

In the present application, unless otherwise clearly defined and limited, if terms such as “install,” “connect,” “connect,” “fix,” etc., appear, these terms should be understood broadly. For example, it can be a fixed connection, a detachable connection, or an integral structure; it can be a mechanical connection or an electrical connection; it can be a direct connection or an indirect connection through an intermediate medium, or it can be an internal connection or an interactive relationship between two elements. Unless otherwise clearly limited, those of ordinary skill in the art can understand the specific meanings of the above-mentioned terms in the present application according to the specific situation.

In the present application, unless otherwise clearly defined and limited, if a first feature is described as being “on” or “under” a second feature, it may mean that the first and second features are in direct contact, or it may mean that the first and second features are in indirect contact through an intermediate medium. Moreover, if the first feature is described as being “above,” “on top of,” or “on” the second feature, it may mean that the first feature is directly above or obliquely above the second feature, or it may simply mean that the first feature is at a higher horizontal level than the second feature. If the first feature is described as being “below,” “under,” or “beneath” the second feature, it may mean that the first feature is directly below or obliquely below the second feature, or it may simply mean that the first feature is at a lower horizontal level than the second feature.

It should be noted that if a component is described as being “fixed to” or “mounted to” another component, it may be directly on the other component or there may be an intermediate component. If a component is described as being “connected to” another component, it may be directly connected to the other component or there may be an intermediate component. If it exists, the terms “vertical,” “horizontal,” “up,” “down,” “left,” “right,” and similar expressions used in the present application are for illustrative purposes only and do not represent the only way of implementation.

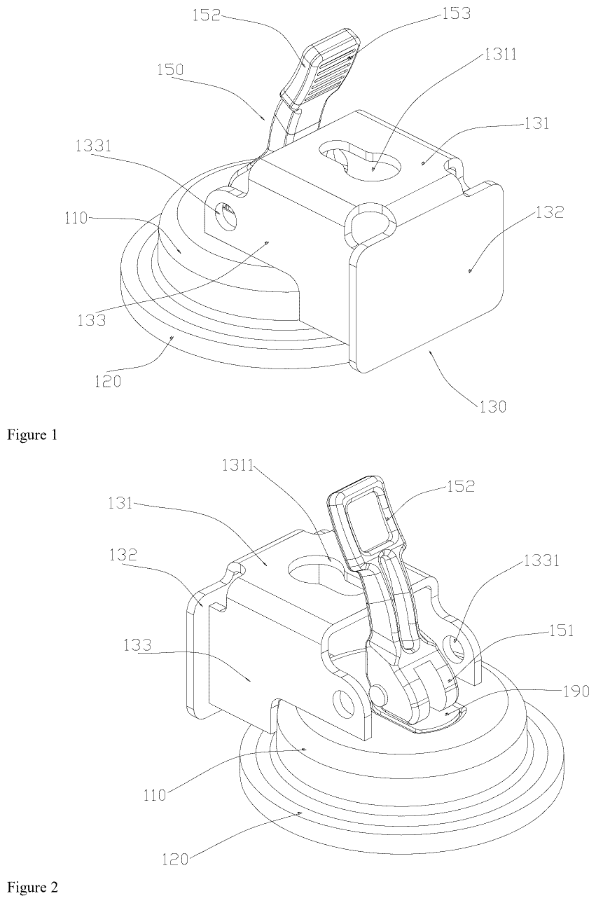

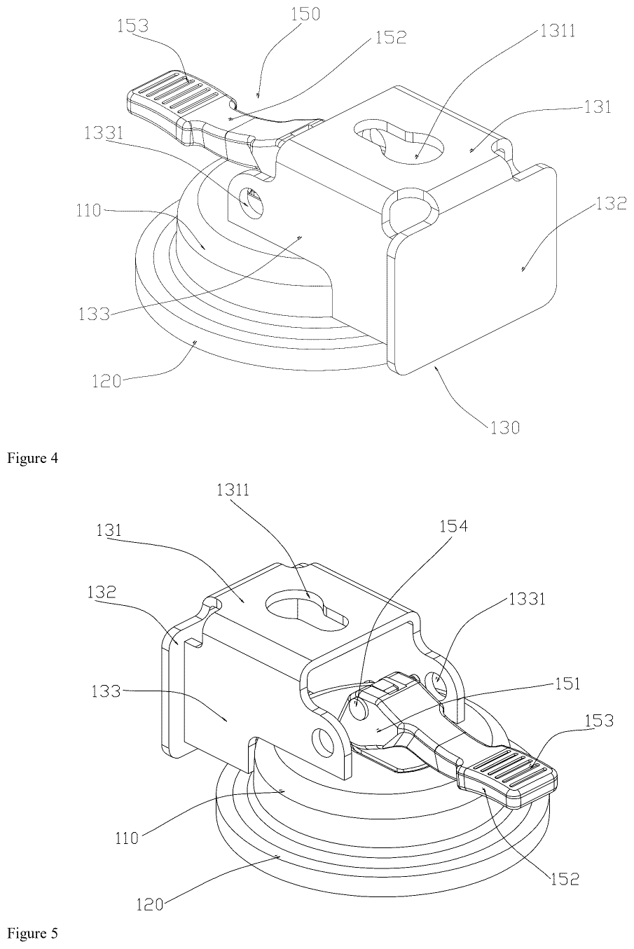

Referring to FIGS. 1 to 7, a floor-moving device is provided, which includes:
A housing 110, the housing 110 having a deformation chamber 111 and an opening 112, the opening 112 communicating with the deformation chamber 111 and being oriented downward;
A suction cup 120, the suction cup 120 being connected to the housing 110 and covering the opening 112, the suction cup 120 being used to adhere to the floor surface;
A striking element 130, the striking element 130 being connected to the housing 110, the striking element 130 being used to allow users to strike it, thereby driving the floor adhered to by the suction cup 120 to move.

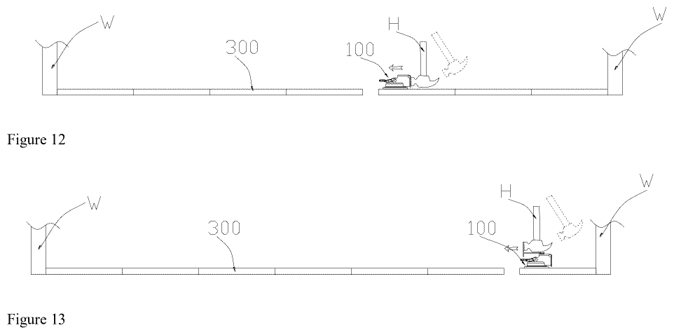

Through the above-mentioned structure, when in use, the suction cup 120 is adsorbed on the floor 300, the edge of the opening 112 of the housing 110 is linked to the edge of the suction cup 120, ensuring that the edge of the suction cup 120 is in the same plane, ensuring the stability of the structure of the suction cup. The deformation chamber 111 allows the upper part of the suction cup 120 to move upward to form a negative pressure between the suction cup 120 and the floor 300 surface, enabling the suction cup 120 to more stably adhere to the floor surface. The striking element 130 is connected to the housing 110, and users can use a hammer or other tools to strike the striking element 130, thereby driving the housing 110, the suction cup 120, and the floor 300 connected to the suction cup 120 to move. This makes it convenient for users to move the floor 300. Moreover, by adsorbing the floor 300 with the suction cup 120, the floor has a larger area of force, preventing floor damage during floor movement. In addition, by setting the striking element 130, the product can have more even force distribution, making it easier for users to move the floor in a specific direction. It is more convenient for users to use and can also prevent the housing 110 from being damaged, which may affect the adsorption effect of the suction cup 120, thereby extending the service life of the product. As shown in FIG. 12, users can use a hammer to strike the striking element 130 to move the floor in the direction of the arrow, adjusting the gap between the floors 300 and the installation position of the floor.

In this embodiment, the striking element 130 has a striking surface, which is used to allow users to strike it. Through the above-mentioned structure, when in use, users can use a hammer or other tools to strike the striking surface, which can provide users with an accurate target area for striking. It is more convenient and accurate for users to use. Moreover, by accurately striking the striking surface, the product can have more even force distribution, allowing users to move the floor in a specific direction and preventing the floor from shifting in other directions when striking the product.

In this embodiment, the normal to the striking surface is substantially perpendicular to the vertical axis of the housing 110. Through the above-mentioned structure, when users strike the striking surface, a force along the normal direction of the striking element 130 is applied, driving the striking element 130, the housing 110, the suction cup 120, and the floor 300 adsorbed by the suction cup 120 to translate. This allows users to control the movement direction of the floor 300, thereby accurately adjusting the position of the floor and improving the efficiency of floor installation and repair work.

In this embodiment, the striking element 130 includes a main body part 131, a striking part 132, and two connecting parts 133. The two connecting parts 133 are bent and extended downward along the two sides of the main body part 131. The striking part 132 is bent and extended downward along the rear side of the main body part 131, and the inner surface of the striking part 132 is in contact with the end surfaces of the two connecting parts 133. Through the above-mentioned structure, the striking element 130 is formed by bending a steel plate. Specifically, the two connecting parts 133 are located on both sides of the main body part 131, and the striking part 132 is located on the rear side of the main body part 131. The main body part 131, the striking part 132, and the two connecting parts 133 are different parts of a steel plate. By bending the two connecting parts 133 and the striking part 132 downward, the inner surface of the striking part 132 is in contact with the end surfaces of the two connecting parts 133, making the product structure more stable, as shown in FIG. 1. When users use a hammer or other tools to strike the striking part 132, the force received by the striking part 132 is transmitted to the connecting parts 133, and then to the housing 110, driving the suction cup 120 and the floor 300 connected to the suction cup 120 to move.

In this embodiment, the lower surface of the connecting part 133 is at least partially connected to the upper surface of the housing 110, and the side of the connecting part 133 away from the striking surface is connected to the side surface of the housing 110. Through the above-mentioned structure, the lower surface of the connecting part 133 is connected to the upper surface of the housing 110, and the contact area between the two is large, making the connection between the connecting part 133 and the housing 110 stable. The side surface of the connecting part 133 is in contact with the side surface of the housing 110, which can stably and evenly transmit the force applied by the user on the striking part 132 to the housing 110, making the product structure more stable and longer-lasting.

In this embodiment, the width of the striking part 132 is greater than the distance between the outer surfaces of the two connecting parts 133. Through the above-mentioned structure, as shown in FIG. 2, the width of the striking part 132 is greater than the distance between the outer surfaces of the two connecting parts 133, that is, the side edge of the striking part 132 protrudes from the outer surface of the connecting part 133. This ensures that the inner surface of the striking part 132 is in contact with the ends of the two connecting parts 133, allowing the force received by the striking part 132 to be transmitted along the extension direction of the connecting part 133 to the housing 110. This enables users to move the floor in a specific direction by striking the striking part 132.

In this embodiment, an extension element 140 is also included. The extension element 140 includes a plug-in block 141, a connecting rod 142, and a striking plate 143. The main body part 131 has a through-hole 1311. The plug-in block 141 is plugged into the through-hole 1311. The first end of the connecting rod 142 is connected to the plug-in block 141. The second end of the connecting rod 142 extends in a direction away from the striking part 132 and is connected to the striking plate 143. The striking element 130 is used to allow users to strike it. When moving the floor close to the wall in the direction away from the wall, the distance between the striking part 132 and the wall is very small, and there is not enough space for users to swing a hammer or other striking tools. Therefore, the extension element 140 can be used. The plug-in block 141 is inserted into the through-hole 1311, and the second end of the connecting rod 142 extends in a direction away from the striking part 132. This creates sufficient distance between the striking plate 143 at the second end of the connecting rod 142 and the wall, allowing users to swing a hammer or other tools to strike the striking plate 143, as shown in FIG. 13, thereby moving the suction cup 120 and the floor 300, making it convenient for users to move the floor close to the wall.

In this embodiment, the second end of the connecting rod 142 is connected to the lower part of the striking plate 143, and the part of the striking plate 143 above the connecting rod 142 that protrudes from the plane of the connecting rod 142 forms a striking area. Through the above-mentioned structure, the upper part of the striking plate 143 protrudes from the plane of the connecting rod 142. When users swing a hammer or other tools, they can strike the striking plate 143 more accurately and conveniently, making it more convenient for users to use.

In this embodiment, the plug-in block 141 includes an upper abutting part 1411, a connecting neck 1412, and a lower abutting part 1413. The upper abutting part 1411 and the lower abutting part 1413 are respectively connected to the upper and lower ends of the connecting neck 1412. The diameters of the upper abutting part 1411 and the lower abutting part 1413 are greater than the diameter of the connecting neck 1412. The upper abutting part 1411 and the lower abutting part 1413 are respectively clamped on the upper and lower sides of the main body part 131. Through the above-mentioned structure, when in use, the plug-in block 141 is inserted into the through-hole 1311. At this time, the upper abutting part 1411 and the lower abutting part 1413 are respectively clamped on the upper and lower sides of the main body part 131. This can effectively connect the plug-in block 141 to the main body part 131, realizing the stable connection between the extension element 140 and the striking element 130. Therefore, the force applied by the user to strike the striking plate 143 can be stably transmitted to the striking element 130, and then to the housing 110 and the suction cup 120, driving the floor 300 to move in a specific direction.

In this embodiment, the through-hole 1311 is in the shape of a light bulb, which includes an insertion area and a clamping area. The insertion area is located on the side of the clamping area away from the striking part 132. The diameter of the clamping area is matched with the diameter of the connecting neck 1412, and the diameter of the insertion area is greater than the diameter of the lower abutting part 1413. Through the above-mentioned structure, when in use, the lower abutting part 1413 is inserted along the insertion area, and then the plug-in block 141 is moved horizontally to make the connecting neck 1412 slide into and clamp in the clamping area. At this time, the upper abutting part 1411 and the lower abutting part 1413 are respectively clamped on the upper and lower sides of the main body part 131, realizing the stable connection between the plug-in block 141 and the main body part 131. The installation is convenient and the structure is stable.

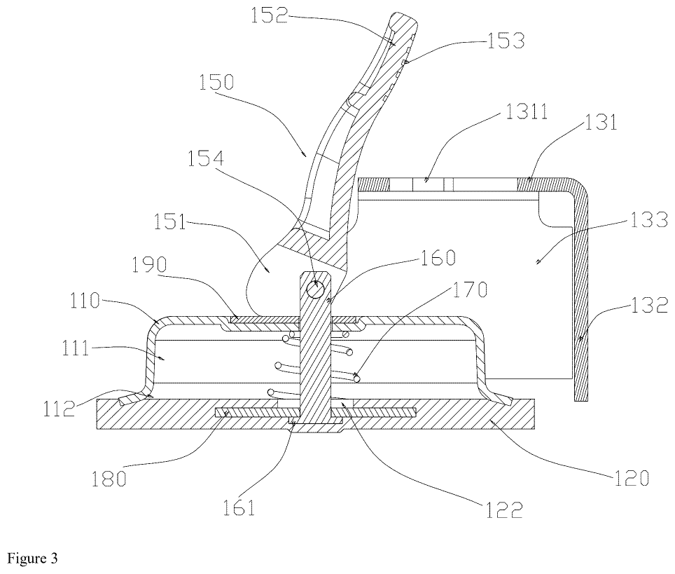

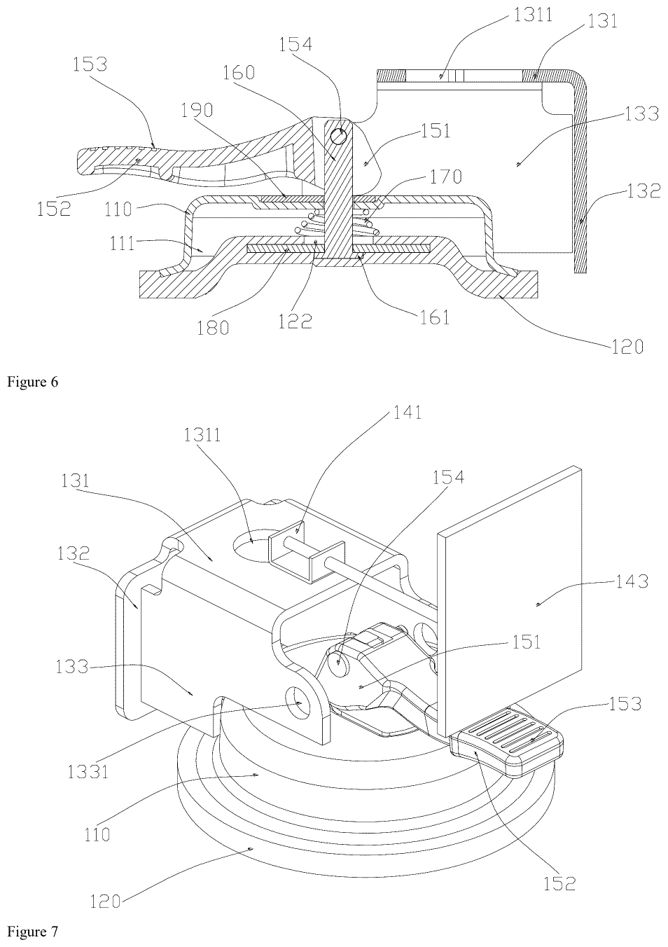

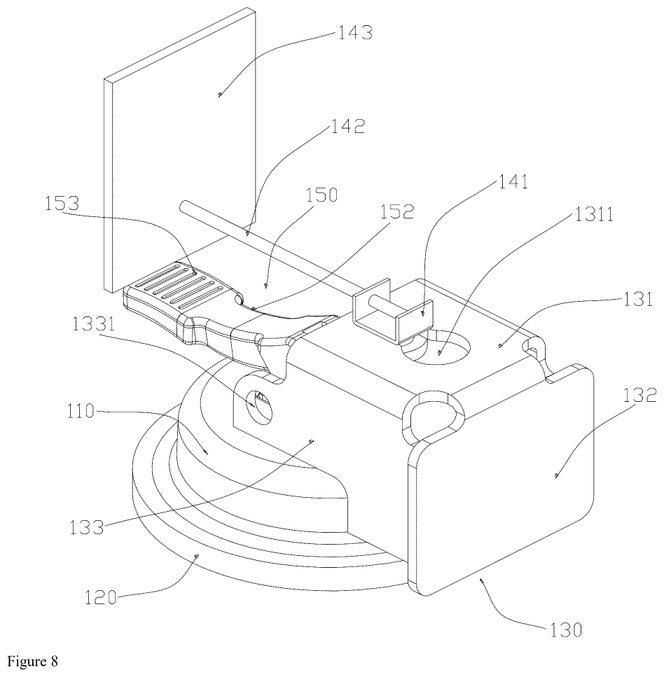

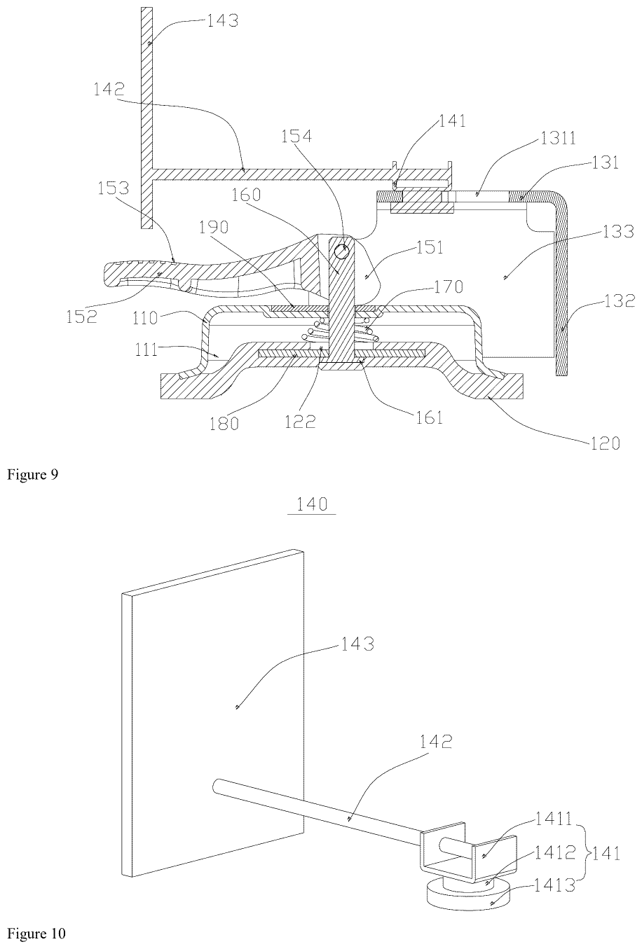

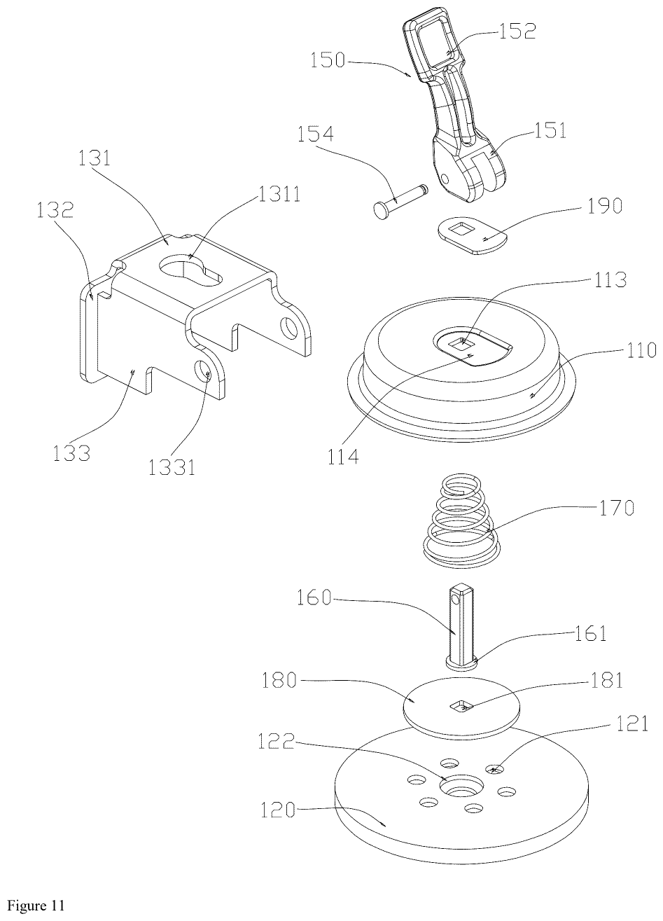

In this embodiment, an eccentric handle 150 and a pull-up column 160 are also included. The housing 110 has an opening 113 in the middle. The lower end of the pull-up column 160 is connected to the suction cup 120, and the upper end of the pull-up column 160 extends out of the opening 113. The eccentric part 151 of the eccentric handle 150 is rotatably connected to the upper end of the pull-up column 160 and is in contact with the housing 110. The eccentric handle 150 drives the suction cup 120 to deform or reset through the pull-up column 160. Through the above-mentioned structure, when in use, the floor-moving device is placed on the floor surface. The eccentric handle 150 is rotated to the suction position. The eccentric part 151 of the eccentric handle 150 pulls up the pull-up column 160, which in turn drives the suction cup 120 connected to the lower end of the pull-up column 160 to deform, as shown in FIG. 6. The negative pressure between the suction cup 120 and the floor surface enables the suction cup 120 to stably adhere to the floor surface, which is convenient to use. When taking off the product, the eccentric handle 150 is rotated in the opposite direction to drive the suction cup 120 to reset, as shown in FIG. 3, so that the suction cup 120 is detached from the floor surface.

In this embodiment, a reset spring 170 is also included. The reset spring 170 is sleeved on the pull-up column 160, and its upper and lower ends are respectively in contact with the lower surface of the housing 110 and the upper surface of the suction cup 120. The reset spring 170 gives the suction cup 120 a tendency to reset. Through the above-mentioned structure, the reset spring 170 is in contact with the lower surface of the housing 110 and the upper surface of the suction cup 120 at its upper and lower ends. When the eccentric handle 150 is rotated to the suction position, the reset spring 170 is compressed. When the eccentric handle 150 is detached from the suction position, the reset spring 170 drives the eccentric handle 150 to move to the release position. The reset spring 170 keeps the suction cup 120 in a flat non-deformed state when the product is not adsorbed on the floor, preventing the suction cup 120 from aging. The reset spring 170 is sleeved on the pull-up column 160, which can define the position of the reset spring 170 and prevent it from deviating, ensuring the stability of the product.

In this embodiment, an installation sheet 180 is also included. The suction cup 120 has an installation slot 121, into which the installation sheet 180 is plugged. The pull-up column 160 is connected to the installation sheet 180. Through the above-mentioned structure, the installation sheet 180 is inserted into the installation slot 121, and the lower end of the pull-up column 160 is connected to the installation sheet 180. When the pull-up column 160 is pulled up, the installation sheet 180 drives the middle part of the suction cup 120 to move upward. The larger contact area between the installation sheet 180 and the suction cup 120 ensures even force distribution among all parts of the suction cup, making the product structure more stable.

In this embodiment, the lower end of the pull-up column 160 has a protruding part 161. The installation sheet 180 has a pull-up column hole 181. The upper end of the pull-up column 160 extends out of the pull-up column hole 181, and the protruding part 161 is in contact with the lower surface of the installation sheet 180. Through the above-mentioned structure, the upper end of the pull-up column 160 is inserted along the pull-up column hole 181 and pulled up until the protruding part 161 at the lower end of the pull-up column 160 is in contact with the lower surface of the installation sheet 180, making the connection between the pull-up column 160 and the installation sheet 180 more stable.

In this embodiment, the upper surface of the suction cup 120 also has an installation hole 122 communicating with the installation slot 121. The diameter of the installation hole 122 is greater than the diameter of the protruding part 161 and smaller than the diameter of the installation sheet 180. Through the above-mentioned structure, the diameter of the installation sheet 180 is greater than the diameter of the installation hole 122, so the installation sheet 180 can be stably fixed in the installation slot 121. The diameter of the installation hole 122 is greater than the diameter of the protruding part 161, which allows the protruding part 161 to be inserted along the installation hole 122.

In this embodiment, the reset spring 170 is a conical spring that is narrow at the top and wide at the bottom. The diameter of the lower end of the reset spring 170 is smaller than the diameter of the installation sheet 180, and the lower end of the reset spring 170 is in contact with the upper surface of the part of the suction cup 120 corresponding to the installation sheet 180. Through the above-mentioned structure, the conical spring has better lateral stability and longer service life. Moreover, it can save installation space and has a larger load capacity.

In this embodiment, a washer 190 is also included. The upper surface of the housing 110 has a washer slot 114, in which the washer 190 is located. The eccentric part 151 of the eccentric handle 150 is in contact with the upper surface of the washer 190. Through the above-mentioned structure, the washer 190 is usually a steel plate. The eccentric part 151 is in contact with the upper surface of the washer 190. The washer 190 evenly transmits the force applied by the eccentric part 151 to the washer 190 to the housing 110. The housing 110 is more evenly stressed, and the pressure on each part is reduced. Moreover, during the rotation of the eccentric part 151, it will not directly wear the surface of the housing 110, but will friction the washer 190. When the washer 190 is worn too much, it is also convenient for users to replace it.

In this embodiment, the eccentric part 151 of the eccentric handle 150 is rotatably connected to the upper end of the pull-up column 160 through a rotating shaft 154. The striking element 130 has an avoidance hole 1331, which is oppositely set to the rotating shaft 154 to allow the rotating shaft 154 to pass through. Through the above-mentioned structure, during the assembly of the product, the rotating shaft 154 can pass through the avoidance hole 1331 to connect the eccentric part 151 of the eccentric handle 150 with the upper end of the pull-up column 160. The avoidance hole 1331 can improve the assembly efficiency of the product.

In this embodiment, the handle part 152 of the eccentric handle 150 rotates between the suction position and the release position. When the handle part 152 is in the release position, the extension direction of the handle part 152 is substantially parallel to the vertical axis of the housing 110. When the handle part 152 is in the suction position, the extension direction of the handle part 152 is substantially perpendicular to the vertical axis of the housing 110, and the extension direction of the handle part 152 is away from the direction of the striking element 130. When the handle part 152 is in the suction position, the extension direction of the handle part 152 is substantially the same as the normal direction of the striking surface, which can avoid the extension element 140 and make it more convenient to install the extension element 140.

In this embodiment, the surface of the handle part 152 has frictional patterns 153.

Through the above-mentioned structure, the frictional patterns 153 enable users to hold the handle part 152 more stably when rotating the eccentric handle 150.

1. A floor-moving device, characterized in that it comprises the following components.
a housing (110), the housing (110) has a deformation chamber (111) and an opening (112), the opening (112) communicates with the deformation chamber (111) and is oriented downward.
a suction cup (120), the suction cup (120) is connected to the housing (110) and covers the opening (112), the suction cup (120) is used to adhere to the floor surface.
a striking element (130), the striking element (130) is connected to the housing (110), the striking element (130) is used to allow users to strike it, thereby driving the floor adhered to by the suction cup (120) to move.

2. The floor-moving device according to claim 1, the striking element (130) has a striking surface, the striking surface is used to allow users to strike it.

3. The floor-moving device according to claim 2, the normal to the striking surface is substantially perpendicular to the vertical axis of the housing (110).

4. The floor-moving device according to claim 2, the striking element (130) comprises a main body part (131), a striking part (132) and two connecting parts (133), the two connecting parts (133) are bent and extended downward along the two sides of the main body part (131), the striking part (132) is bent and extended downward along the rear side of the main body part (131), and the inner surface of the striking part (132) is in contact with the end surfaces of the two connecting parts (133).

5. The floor-moving device according to claim 4, the lower surface of the connecting part (133) is at least partially connected to the upper surface of the housing (110), and the side of the connecting part (133) away from the striking surface is connected to the side surface of the housing (110).

6. The floor-moving device according to claim 4, the width of the striking part (132) is greater than the distance between the outer surfaces of the two connecting parts (133).

7. The floor-moving device according to claim 4, further comprising an extension element (140), the extension element (140) comprises a plug-in block (141), a connecting rod (142) and a striking plate (143), the main body part (131) has a through-hole (1311), the plug-in block (141) is plugged into the through-hole (1311), the first end of the connecting rod (142) is connected to the plug-in block (141), the second end of the connecting rod (142) is extended in a direction away from the striking part (132) and is connected to the striking plate (143), the striking element (130) is used to allow users to strike it.

8. The floor-moving device according to claim 7, the second end of the connecting rod (142) is connected to the lower part of the striking plate (143), and the part of the striking plate (143) above the connecting rod (142) that is higher than the plane of the connecting rod (142) forms a striking area.

9. The floor-moving device according to claim 7, the plug-in block (141) comprises an upper abutting part (1411), a connecting neck (1412) and a lower abutting part (1413), the upper abutting part (1411) and the lower abutting part (1413) are respectively connected to the upper and lower ends of the connecting neck (1412), the diameters of the upper abutting part (1411) and the lower abutting part (1413) are greater than the diameter of the connecting neck (1412), the upper abutting part (1411) and the lower abutting part (1413) are respectively clamped on the upper and lower sides of the main body part (131).

10. The floor-moving device according to claim 9, the through-hole (1311) is in the shape of a light bulb, which includes an insertion area and a clamping area, the insertion area is located on the side of the clamping area away from the striking part (132), the diameter of the clamping area is matched with the diameter of the connecting neck (1412), and the diameter of the insertion area is greater than the diameter of the lower abutting part (1413).

11. The floor-moving device according to claim 1, further comprising an eccentric handle (150) and a pull-up column (160), the housing (110) has an hole (113) in the middle, the lower end of the pull-up column (160) is connected to the suction cup (120), the upper end of the pull-up column (160) extends out of the hole (113), the eccentric part (151) of the eccentric handle is rotatably connected to the upper end of the pull-up column (160) and is in contact with the housing (110), and drives the suction cup (120) to deform or reset through the pull-up column (160).

12. The floor-moving device according to claim 11, further comprising a reset spring (170), the reset spring (170) is sleeved on the pull-up column (160), and its upper and lower ends respectively are in contact with the lower surface of the housing (110) and the upper surface of the suction cup (120), the reset spring (170) enables the suction cup (120) to have a tendency to reset.

13. The floor-moving device according to claim 12, further comprising an installation sheet (180), the suction cup (120) has an installation slot (121), the installation sheet (180) is plugged into the installation slot (121), and the pull-up column (160) is connected to the installation sheet (180).

14. The floor-moving device according to claim 13, the lower end of the pull-up column (160) has a protruding part (161), the installation sheet (180) has a pull-up column hole (181), the upper end of the pull-up column (160) extends out of the pull-up column hole (181), and the protruding part (161) is in contact with the lower surface of the installation sheet (180).

15. The floor-moving device according to claim 14, the upper surface of the suction cup (120) also has an installation hole (122) communicating with the installation slot (121), the diameter of the installation hole (122) is greater than the diameter of the protruding part (161) and smaller than the diameter of the installation sheet (180).

16. The floor-moving device according to claim 13, the reset spring (170) is a conical spring that is narrow at the top and wide at the bottom, the diameter of the lower end of the reset spring (170) is smaller than the diameter of the installation sheet (180), and the lower end of the reset spring (170) is in contact with the upper surface of the part of the suction cup (120) corresponding to the installation sheet (180).

17. The floor-moving device according to claim 11, further comprising a washer (190), the upper surface of the housing (110) has a washer slot (114), the washer (190) is located in the washer slot (114), and the eccentric part (151) of the eccentric handle (150) is in contact with the upper surface of the washer (190).

18. The floor-moving device according to claim 11, the eccentric part (151) of the eccentric handle (150) is rotatably connected to the upper end of the pull-up column (160) through a rotating shaft (154), the striking element (130) has an avoidance hole (1331), the avoidance hole (1331) is oppositely set to the rotating shaft (154) to allow the rotating shaft (154) to pass through.

19. The floor-moving device according to claim 11, the handle part (152) of the eccentric handle (150) rotates between the suction position and the release position, when the handle part (152) is in the release position, the extension direction of the handle part (152) is substantially parallel to the vertical axis of the housing (110); when the handle part (152) is in the suction position, the extension direction of the handle part (152) is substantially perpendicular to the vertical axis of the housing (110), and the extension direction of the handle part (152) is away from the direction of the striking element (130).

20. The floor-moving device according to claim 19, the surface of the handle part (152) has frictional patterns (153).
